(19) United States
(12) Patent Application Publication
(10) Pub. No.: US 2007/0218730 A1
(43) Pub. Date: Sep. 20, 2007

(54) Cable securing structure in a terminal seat

(76) Inventor: Jack Wu, Taipei Hsien (TW)

Correspondence Address: BACON & THOMAS, PLLC, 625 SLATERS LANE, FOURTH FLOOR, ALEXANDRIA, VA, 22314, US

(21) Appl. No.: 11/595,980

(22) Filed: Nov. 13, 2006

(30) Foreign Application Priority Data
Mar. 16, 2006 (TW) 095204306

(51) Int. Cl. H01R 3/00

(52) U.S. Cl. 439/164

(57) ABSTRACT

A terminal seat includes a cable securing plate (30) and a cable conducting member (40). The cable securing plate (30) has a hole (31), a bend (33) formed on a free side thereof and extending toward the hole (31) and a sharp edge (32) formed on a side face defining the hole (31). The conducting member (40) has two legs (41) and an extension (42) extending oppositely relative to the two legs (41) and into the hole (31) of the cable securing plate (30) so that a cable extended into a gap between the extension (42) and the sharp edge (32) is able to be securely clamped therebetween.

### BACKGROUND OF THE INVENTION

1. Field of the Invention

The present invention relates to a cable securing structure, and more particularly to a cable securing structure in a terminal seat to securely grab the cable extended into the terminal seat to prevent disconnection of the cable to the terminal seat when a force directed away from the terminal seat is applied to the cable.

2. Description of the Prior Art

With reference to FIGS. 7 and 8, a conventional terminal seat is composed of a body (10), a securing plate (14), a conducting member (15) and a cap (19).

The body (10) is hollow and has an opening (11) defined in a side thereof, a through hole (12) defined in another side of the body (10) to be close to and communicate with the opening (11) and two outlets (13) defined in the side defining the opening (11) to respectively communicate with the opening (11).

The securing plate (14) is arcuate in shape and has a hole (18) defined through a side thereof. A free end side of the securing plate (14) is provided with a bend extending toward the hole (18).

The conducting member (15) has two legs (16) extending downward to correspond to the two outlets (13) of the body (10) and a cable engagement plate (17) stamped out from a side of the conducting member (15) and extended toward the hole (18) of the securing plate (14).

The securing plate (14) as well as the conducting member (15) is inserted into the body (10) from the opening (11). The cable engagement plate (17) is extending outward from the hole (18) of the securing plate (14) and the two legs (16) are extending from the two outlets (13) of the body (10). Then the cap (19) is employed to close the opening (11) of the body (10). Thereafter, a tool (not shown) is applied to force the cable engagement plate (17) to leave a side face defining the hole (18) so that a cable (20) (in dashed lines) is able to extend into a space between the cable engagement plate (17) and the side face defining the hole (81). Because the cable engagement plate (17) is forced to leave the side face defining the hole (18), after the tool is removed, the cable engagement plate (17) moves back trying to engage with the side face defining the hole (18). Thus the cable (20) is securely sandwiched between the cable engagement plate (17) and the side face defining the hole (18).

From the depiction of FIG. 8, it is noted that the cable engagement plate (17) is smooth and the side face defining the hole (18) is also smooth such that when an external force is exerted on the cable (20), the clamping force to the cable from the cable engagement plate (17) and the side face defining the hole (18) can not hold the cable in position and electrical connection in the terminal seat is disconnected. That is, the conventional cable securing structure in the terminal seat can not satisfy the requirements.

To overcome the shortcomings, the present invention tends to provide an improved cable securing structure to mitigate the aforementioned problems.

### SUMMARY OF THE INVENTION

The primary objective of the present invention is to provide an improved cable securing structure to securely hold the cable extended into the terminal seat.

In order to accomplish the above objective, the cable securing structure of the present invention includes a conducting member and a cable securing plate. The conducting member has a hole and a bend formed on a free side thereof and extending toward the hole. A side face defining the hole is provided with a sharp edge. The cable securing plate has two legs and an extension extending oppositely relative to the two legs and having a knurl facing the sharp edge of the conducting member. Therefore, when a cable is extended into a gap between the extension and the sharp edge, the extension engages with the cable and abuts the cable against the sharp edge. Thus the cable is securely clamped by the extension and the sharp edge.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a terminal seat;

FIG. 2 is an exploded perspective view showing that a cable is introduced to the securing plate and the conducting member;

FIG. 3 is a perspective view showing that the cable is extended into the combination of the conducting member and the cable securing plate;

FIG. 4 is a cross sectional view showing the cable is securely clamped by the extension and the sharp edge;

FIG. 5 is an operational view showing that the cable is secured in the cable securing structure of the present invention even when an external force is pulling the cable out of the cable securing structure;

FIG. 6 is an enlarged cross sectional view showing that the sharp edge extends into the sheath of the cable;

FIG. 7 is an exploded perspective view of a conventional cable securing structure in a terminal seat; and

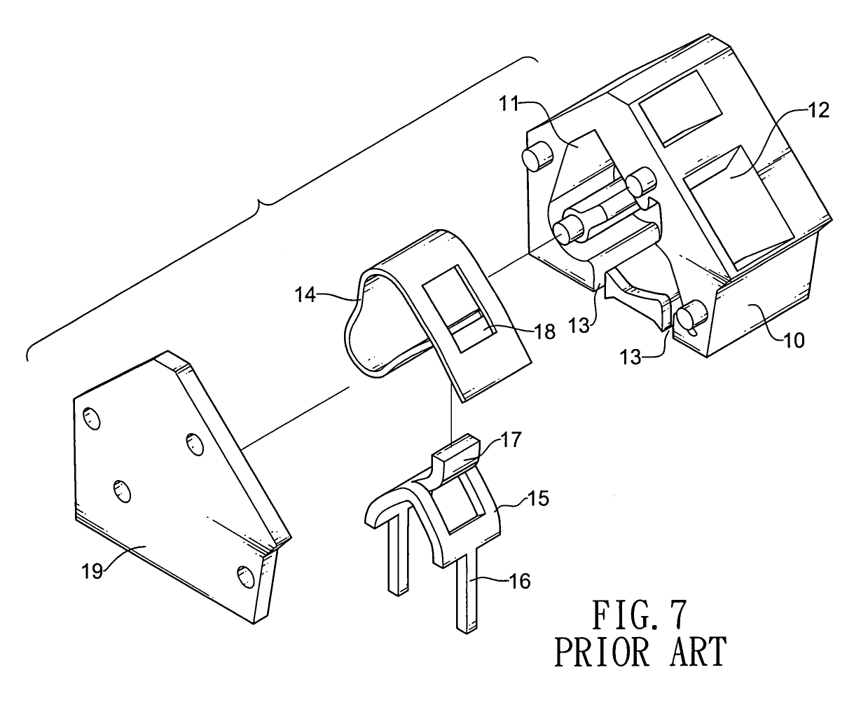

FIG. 8 is a schematic cross sectional view showing the cable is extended into the combination of the conventional terminal seat.

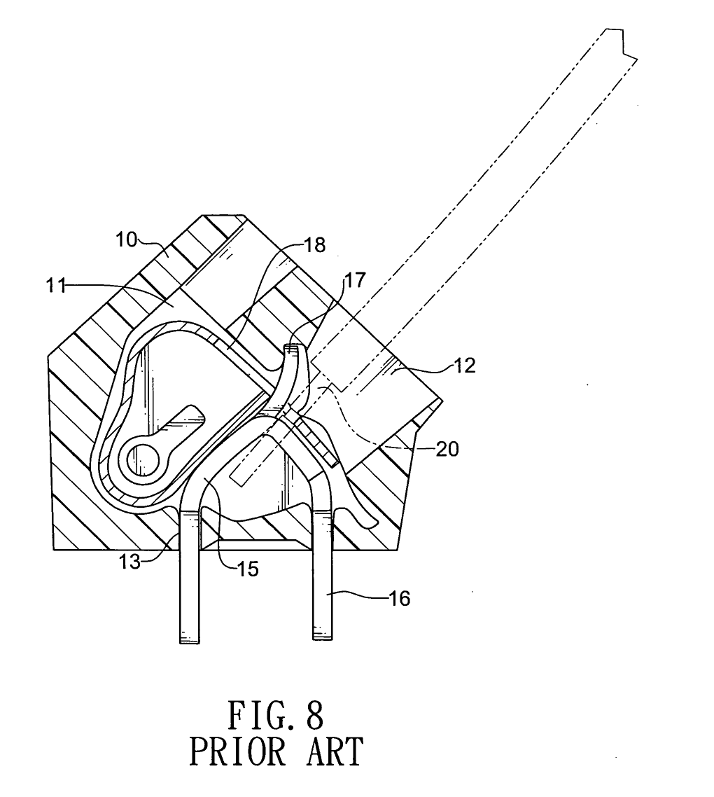

### DETAILED DESCRIPTION OF THE PREFERRED EMBODIMENT

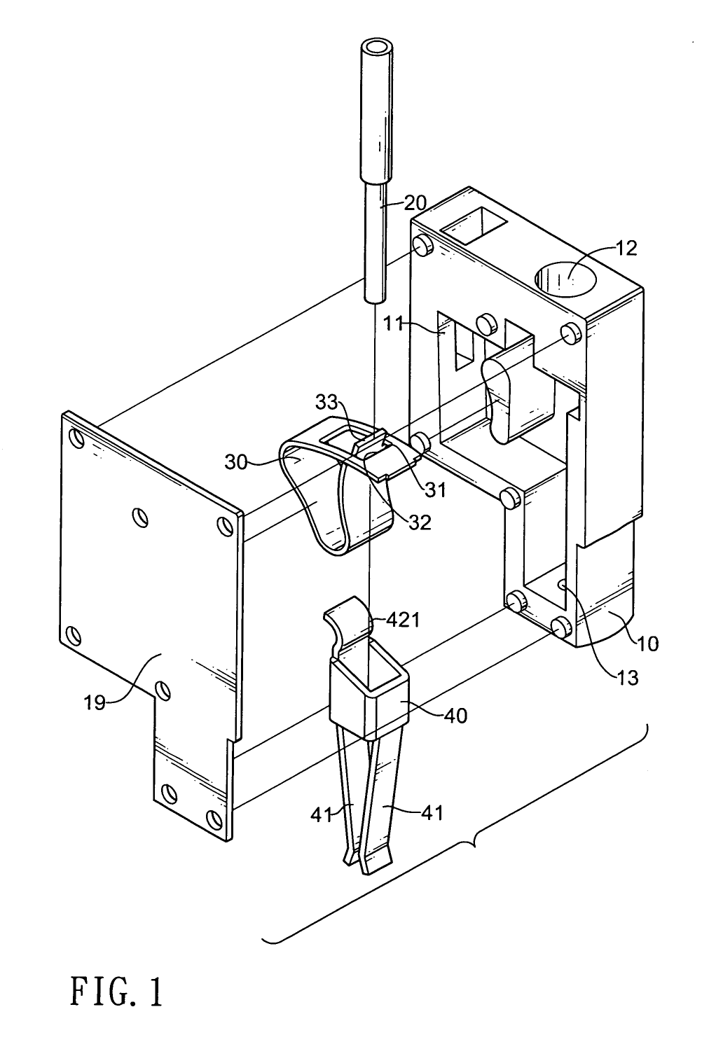

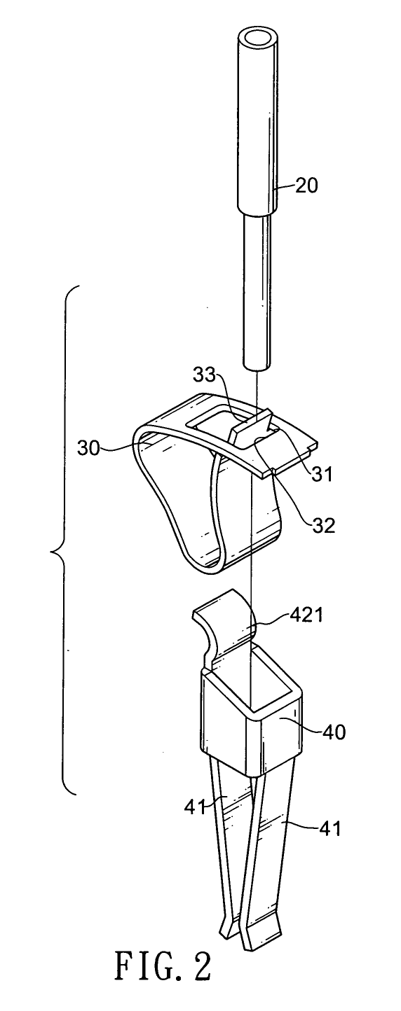

With reference to FIGS. 1 and 2, it is noted that the cable securing structure in accordance with the present invention includes a body (10), a cable securing plate (30), a conducting member (40) and a cap (19) for closing the opening (11) of the body (10). The detailed structure of the body (10) is the same as that described in the background such that no additional description is given concerning the structure of the body (10). However, the same structure and/or the same reference numerals are used throughout the entire specification.

The cable securing plate (30) has a hole (31) and a bend (33) formed on a free side thereof and extending toward the hole (31). A side face defining the hole (31) is provided with a sharp edge (32). The conducting member (40) has two legs (41) and an extension (42) extending oppositely relative to the two legs (41) and having a knurl (421) formed on the extension (42) to face the sharp edge (32) of the cable securing plate (30).

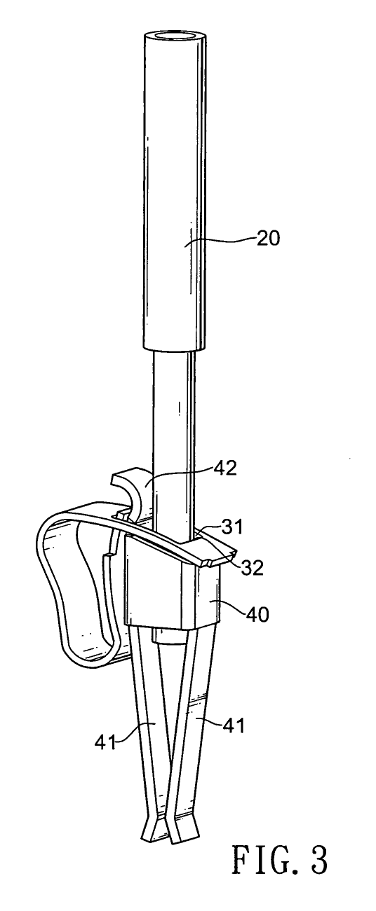

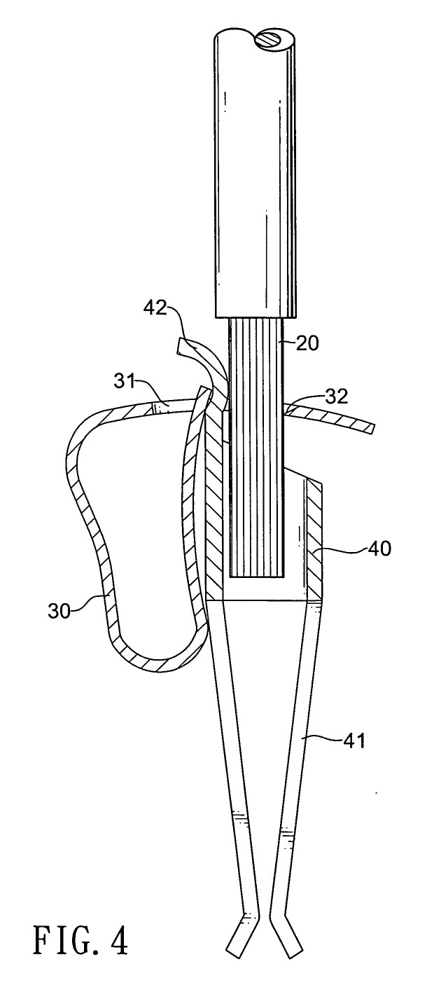

With reference to FIGS. 3 and 4, when the cable securing plate (30) and the conducting member (40) are combined, it is noted that the extension (42) of the conducting member (40) extends out of the hole (31) of the cable securing plate (30) and the bend (33) is beneath the extension (42) to support the extension (42). Thus when a cable (20) is extended into a gap between the extension (42) and the sharp edge (32), the cable (20) is securely sandwiched between the knurl (421) of the extension (42) and the sharp edge (32) of the cable securing plate (30).

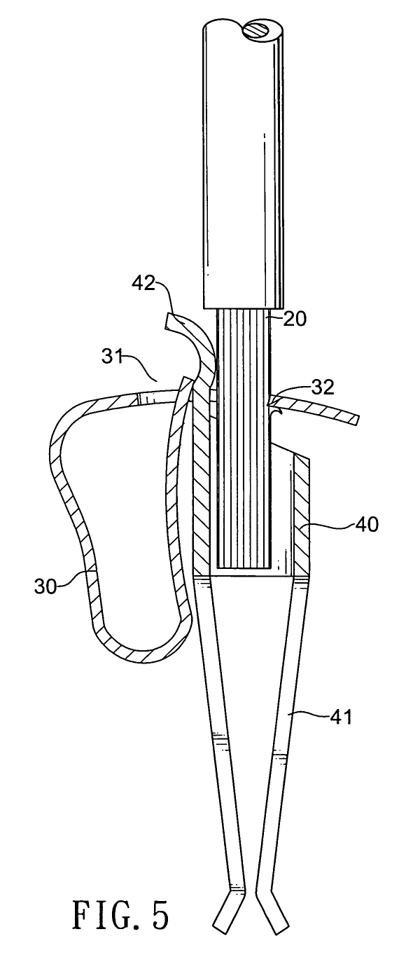

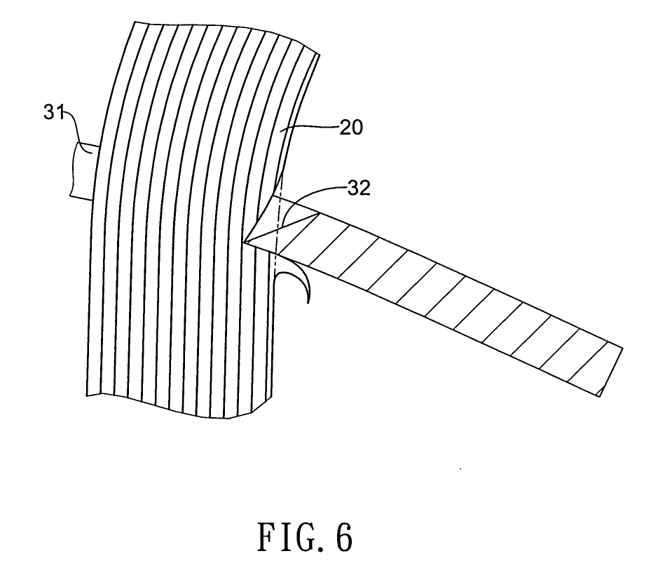

With reference to FIGS. 5 and 6, after the combination of the cable securing plate (30) and the conducting member (40) is finished, if there is an external force applied to the cable (20) which is sandwiched between the knurl (421) and the sharp edge (32) trying to pull the cable (20) away from the combination, the sharp edge (32) of the cable securing plate (30) is able to extend through an external sheath of the cable (20) to further secure the cable (20) in the cable securing structure of the present invention, which satisfactorily meets the requirements.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A terminal seat having a body (10) with two outlets (13), a cable securing plate (30) securely received in the body (10) and a conducting member (40) securely received in the body (10), characterized in that:
the cable securing plate (30) has a hole (31), a bend (33) formed on a free side thereof and extending toward the hole (31) and a sharp edge (32) formed on a side face defining the hole (31),
the conducting member (40) has two legs (41) extending out of the two outlets (13) respectively and an extension (42) extending oppositely relative to the two legs (41) and into the hole (31) of the cable securing plate (30) so that a cable (20) extended into a gap between the extension (42) and the sharp edge (32) is able to be securely clamped therebetween.
